(19) United States
(12) Patent Application Publication
(10) Pub. No.: US 2026/0327430 A1
(43) Pub. Date: Oct. 22, 2026

(54) MULTILAYERED EFFECT PIGMENTS COMPRISING BIODEGRADABLE POLYMERS

(71) Applicant: MERCK PATENT GMBH, Darmstadt (DE)

(72) Inventor: Carsten PLUEG, Darmstadt (DE)

(73) Assignee: MERCK PATENT GMBH, Darmstadt (DE)

(21) Appl. No.: 19/103,563

(22) PCT Filed: Aug. 14, 2023
(86) PCT No.: PCT/EP2023/072356

§ 371 Date: Feb. 13, 2025

(30) Foreign Application Priority Data
Aug. 17, 2022 (EP) 22190685

(51) Int. Cl. C09C 1/00; B29C 48/08; B29C 48/305; B29K 67/00; B29K 505/02; B29L 7/00; B29L 9/00; B29L 31/00; C09C 1/64

(52) U.S. Cl. CPC C09C 1/0075; B29C 48/08; B29C 48/307; C09C 1/646; B29C 2948/92247; B29C 2948/92342; B29K 2067/006; B29K 2067/046; B29K 2505/02; B29L 2007/008; B29L 2009/00; B29L 2031/712; C09C 2200/302; C09C 2200/303; C09C 2200/308

(57) ABSTRACT

Effect pigments and multilayered films from two or more biodegradable polymer layers having different refractive indices and in alternating order, a method for producing them, and their use, inter alia, in cosmetic products, rinse-off products, packaging materials, decorative films, paints, printing inks and plastics.

### CROSS-REFERENCE TO RELATED APPLICATIONS

This is a PCT National Stage application filed under 35 U.S.C. § 371(c), claiming priority benefit under 35 U.S.C. § 365(a) of and to PCT International Application No. PCT/EP2023/072356, filed Aug. 14, 2023, which claims priority benefit under 35 U.S.C. § 365(b) of and to EP Patent Application No. 22190685.2, filed Aug. 17, 2022, the entire contents of which documents are incorporated herein by reference in their entirety and for all purposes.

### BACKGROUND OF THE INVENTION

The present invention relates to effect pigments and multilayered films comprising two or more biodegradable polymer layers of different refractive index and in an alternating sequence, to processes for the preparation thereof, and to the use thereof, inter alia in cosmetic products, rinse-off products, packaging materials, decorative films, paints, printing inks and plastics.

Conventional decorative or effect films often consist of uniaxially or biaxially stretched polyester films, which consist, for example, of alternating polymer layers, such as PET (polyethylene terephthalate) and PBT (polybutylene terephthalate). Stretching the multilayered films leads to a different degree of orientation and therefore a different degree of refraction in the alternating layers and consequently an angle-dependent colour effect. Additional colouring of the films, e.g. with sol-vent dyes, enables an individual hue to be set. A barrier effect in combination with a reflective effect can optionally additionally be established by application of a metal layer, usually aluminium. Films of this type are used as packaging materials, e.g. for gifts, flowers and foods. Glitter particles, which are used in cosmetics, rinse-off products, such as shower gel, or in toys, can be derived from such films, e.g. by grinding, cutting or stamping.

The polymer chain alignment ordered in a stretching process requires the use of polyesters with an aromatic dicarboxylic acid, in particular terephthalic acid, as monomer component. However, these materials are not biodegradable and are currently not accessible from renewable raw material sources in an economically viable manner.

U.S. Pat. No. 6,299,979 describes a polymeric colour-effect pigment comprising a multiplicity of layers of thermoplastic organic materials of different refractive indices. However, biodegradable materials are not mentioned therein.

US 2007/014977 A1 describes multilayered, iridescent films which consist of alternating, biodegradable poly(lactic acid) layers and non-biodegradable polytere-phthalate layers. The films are produced by co-extrusion of the two polymers and subsequently preferably stretched in order to increase the refractive index difference and to obtain a more intense hue. It is furthermore described that the films can also be comminuted for the production of glitter particles. However, the poly-terephthalate films used are not biodegradable and are also not accessible from renewable raw material sources in an economically viable manner. Furthermore, the additional process step of stretching of the films means that the production process is more time-consuming and expensive.

US 2013/0295355 A1 describes a biodegradable, multilayered, transparent and flexible packaging film consisting of at least one first, PLA-based polymer layer and a second, aliphatic or aliphatic-aromatic copolyester layer, which are arranged alternately, where the first polymer layer forms the outer layer. The film may optionally also comprise a third polymer layer consisting of an aliphatic or aliphatic-aromatic polyester-based polymer which is different from the second polymer layer and is arranged between the first and second polymer layers. This multilayered film is produced by melt extrusion of each polymer and alternate lamination of the extrudates with subsequent stretching. It is furthermore described that the individual layer thicknesses of the polymer layers should be between 133 and 5000 nm, since, in the case of an individual layer thickness of less than 133 nm (at a refractive index of n=1.465), undesired interference phenomena in the visible wavelength range, in particular reddish interference at 780 nm, arise for the transparent films described. However, this lower limit of the individual layer thickness greatly restricts the available parameter latitude for achieving further, different hues. In addition, the additional process step of stretching of the films means that the production process is more time-consuming and expensive.

However, the effect pigments and multilayered films according to the invention and the advantages achieved thereby were neither described in the prior art nor obvious from it.

### SUMMARY OF THE INVENTION

The object of the present invention is therefore to prepare biodegradable effect pigments and multilayered films from renewable raw materials (i.e. consisting of a proportion of more than >50% of bio-based raw materials) which consist of biodegradable polymers, but without contributing to a further increase in microplastics in the environment, which preferably require neither metallic nor inorganic layers, and which can be prepared in a simple and inexpensive process from commercially available starting materials in a wide variety of colours.

This object has been achieved in accordance with the invention by effect pigments and multilayered films as described and claimed in the present application. In particular, it has surprisingly been found that this object can be achieved by obtaining pigments from a multilayered film which consists of a multiplicity, e.g. 64 to 256, optically active individual layers in an alternating structure, comprising only two polymers having different refractive indices, which are commercially available and are preferably accessible from natural sources and are biodegradable. The polymer layers can be simultaneously extruded, cut and stacked, do not have to be stretched subsequently, and exhibit very good adhesion without further assistants and, depending on the layer thickness and the refractive index, a colour effect with a metallic appearance generated by interference. These multilayered films can be comminuted into particles of suitable size, for example by grinding, cutting or stamping, which can subsequently be used as effect pigments.

Furthermore, it has surprisingly been found that a material combination of the two commercially available and biodegradable polymers polylactide (in particular as D/L copolymer) and PBAT (polybutylene adipate terephthalate), in particular as random copolymer, is particularly suitable for use in the effect pigments and multilayered films according to the invention.

The present invention therefore relates to an effect pigment comprising, preferably consisting of, two or more transparent layers of a first polymer and two or more transparent layers of a second polymer, where the two polymers have a different refractive index and the layers of the first polymer and the layers of the second polymer are arranged in an alternating sequence, and where the two polymers are selected from biodegradable polymers.

The invention furthermore relates to a process for the preparation of an effect pigment as described above and below, characterised in that the first and second polymers are each coextruded, preferably at elevated temperature, placed one on top of the other, optionally cut, stacked and brought into a multilayered film structure through a film die, preferably at elevated temperature, where the steps described above may also be repeated multiple times, and where the polymer films are preferably not stretched or oriented after extrusion, the multilayered film obtained in this way is stamped, ground, cut or comminuted into particles in another manner, and the particles are optionally classified according to size.

The invention furthermore relates to a multilayered film comprising, preferably consisting of, two or more transparent layers of a first polymer and two or more transparent layers of a second polymer as described above and below, where the two polymers have a different refractive index and the layers of the first polymer and the layers of the second polymer are arranged in an alternating sequence, the two polymers are selected from biodegradable polymers, and the average individual layer thickness of all polymer layers is ≤130 nm.

The invention furthermore relates to a process for the production of a multilayered film as described above and below, characterised in that the first and second polymers are each coextruded, preferably at elevated temperature, placed one on top of the other, optionally cut, stacked and brought into a multilayered film structure through a film die, preferably at elevated temperature, where the steps described above may also be repeated multiple times, and where the polymer films are preferably not stretched or oriented after extrusion.

The invention furthermore relates to a formulation comprising one or more effect pigments according to the invention, in particular for use in the products and uses above and below.

The invention furthermore relates to the use of the effect pigments, multilayered films and formulations according to the invention as described above and below, preferably in products selected from the group consisting of cosmetic products, rinse-off products, packaging materials, decorative films, paints, printing inks and plastics.

The invention furthermore relates to products comprising one or more effect pigments according to the invention, a formulation according to the invention or a multilayered film according to the invention as described above and below, in particular selected from the group consisting of cosmetic products, rinse-off products, packaging materials, decorative films, paints, printing inks and plastics.

According to the EPA network (European Network of the Heads of Environment Protection Agencies Plastics Interest Group, Working Paper Nov. 2018*), the term “biodegradable polymers/plastics” as used above and below refers to materials that can potentially be converted into naturally occurring metabolic end products through biological activity (enzymatic cleavage and metabolism with bacteria/fungi). Ideally, this chemical metabolic process leads to mineralisation of the plastics into e.g. oxygen, carbon dioxide and salts thereof, carbon and methane.

The effect pigments and multilayered films according to the invention are distinguished, inter alia, by an angle-dependent colour effect, good adhesion of the individual layers and good processing properties. In addition, they comprise biodegradable materials made from sustainable raw materials, preferably consisting of a proportion of more than >50% of bio-based raw materials, and no inorganic or metallic layers, like the commercially available effect films and glitter pigments known to date.

The polymers used in the effect pigments and multilayered films according to the invention can be simultaneously extruded, cut and stacked, do not have to be stretched subsequently and exhibit very good adhesion without any additional assistants. Suitable polymers are commercially available.

The pigments and multilayered films according to the invention preferably consist exclusively of organic materials, particularly preferably of biodegradable organic materials, and are preferably free from inorganic materials.

The two polymers are preferably selected from organic polymers, which may also be crosslinked, and which are biodegradable.

A particularly preferred material combination consists of PLA (polylactic acid, e.g. prepared from renewable corn starch), preferably a copolymer of D- and L-lactic acid monomers, or a PLA blend, as the first polymer and PBAT (polybutylene adipate/terephthalate), preferably as random copolymer, as the second polymer.

This combination is particularly advantageous since the two copolymers can be coextruded in the same temperature range and their rheological properties, such as viscosity, are well matched.

Further preferred biodegradable polymers are blends of thermoplastic starch (TPS) with the abovementioned or other biodegradable polymers, blends of PBAT with PLA (e.g. Ecovio series from BASF), bio-PA6 and bio-PA11 or polyhydroxy-alkanoates, such as polyhydroxybutyrate-co-hydroxyvalerate (PHB/PHV).

Depending on the polymer combination selected and the refractive index difference An between the first and second polymers, also referred to below as polymer A and polymer B, nanoscale polymer layer thicknesses d_{polymer A/B}, in which n_{polymer A B} denotes the refractive index of polymer A or B, and where the polymer films are not oriented or stretched, arise in principle for optically visible interference effects having a reflection peak λₚₑₐₖ in the wavelength range λ=380 to 740 nm in accordance with the following equation (1). Only 1st order interference is considered here, since the colour effects due to 2nd order interference are only very weak:

λₚₑₐₖ=2(n_{PolymerA}*d_{PolymerA}+n_{PolymerB}*d_{PolymerB}) (1)

### BRIEF DESCRIPTION OF THE DRAWING FIGURES

FIG. 1 shows by way of example a schematic representation of the formation of the interference effect in effect pigments and multilayered films according to the invention having an alternating, optically active stack sequence ABABA of individual layers of polymer A (PLA) having a refractive index n of 1.436 and a layer thickness da, and individual layers of polymer B (PBAT) having a refractive index n of 1.598 and a layer thickness de, where the incident light (arrow “a”) is reflected at each interface at which the refractive index changes and the reflected light waves (arrows “b”) interfere. The transmitted light is indicated by arrow “c”. The multilayered film is optionally terminated with one and the same polymer layer A or B (here: A) on the front and back in order to achieve the requisite film stability. The thickness of these stabilising top layers is about 8% of the total film thickness and has only a marginal influence on the interference effect.

FIG. 2 shows by way of example the formation of the visible interference effect, generated by the superposition of the reflected radiation having a correspondingly suitable reflection wavelength depending on the individual layer thickness d of the polymers in effect pigments and multilayered films according to the invention having a stack sequence ABABAB . . . A (here A as a stabilising top layer) and the material combination PLA/PBAT.

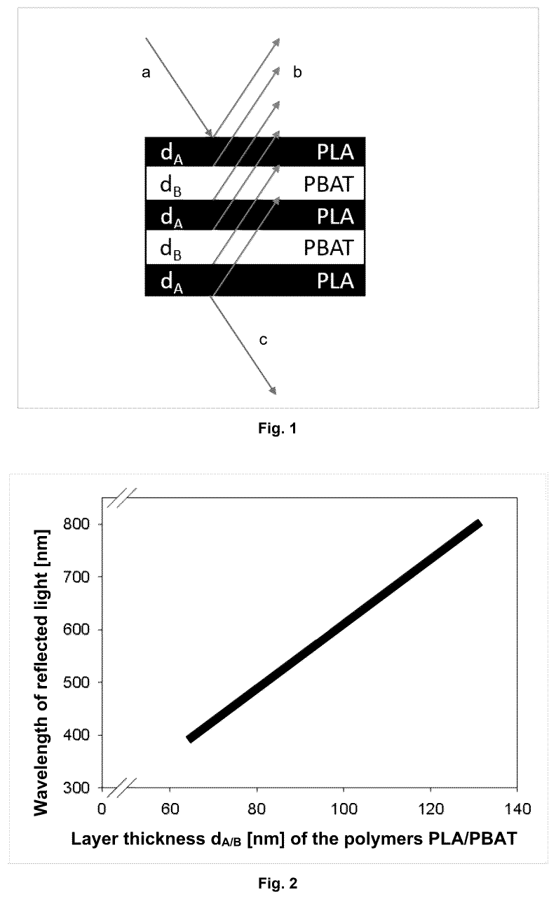

### DETAILED DESCRIPTION OF THE INVENTION

By specific variation of the individual layer thicknesses, the desired reflection wavelengths and hues can be achieved for a specified refractive index.

In a preferred embodiment of the invention, the effect pigments and multilayered films have an alternating stack sequence (ABAB . . . ), where A denotes a single layer of the first polymer (polymer A) and B denotes a single layer of the second polymer (polymer B), and where one of the polymers (polymer A or B) forms the two outer top layers. e.g. ABABABAB . . . A or BABABA . . . B. The total number of all optically active single layers of the first and second polymers in the inventive effect pigments and multilayered films of this preferred embodiment is preferably 7 to 2049, in particular 15 to 1025, particularly preferably 31 to 513, very particularly preferably 63 to 257.

In a further preferred embodiment of the invention, the effect pigments and multilayered films have an alternating stack sequence (ABAB . . . ), where A denotes a single layer of the first polymer (polymer A) and B denotes a single layer of the second polymer (polymer B), e.g. ABABAB . . . AB. The total number of all optically active single layers of the first and second polymers in the inventive effect pigments and multilayered films of this preferred embodiment is preferably 8 to 2048, in particular 16 to 1024, particularly preferably 32 to 512, very particularly preferably 64 to 256.

The average individual layer thickness of all the polymer layers (i.e. in each of them) in the effect pigments and multilayered films according to the invention is preferably ≤130 nm, particularly preferably 40 to 130 nm, very particularly preferably 60 to 130 nm. The respective colour effects can be adjusted by combinations of different layer thicknesses dpolymer A and dpolymer B. In practice, the ratio of the layer volumes of the individual layers A and B is for this purpose varied, e.g. to 25% by vol: 75% by vol, 50% by vol: 50% by vol or 75% by vol: 25% by vol. Differences in the individual layer thicknesses in the multilayered films lead to multicoloured effects, which can absolutely also find applications and may be desired.

In a particularly preferred embodiment of the invention, the effect pigments and multilayered films according to the invention have a reflection wavelength in the visible region of the spectrum, in particular in the range from 450 to 750 nm.

The total thickness of all polymer layers in the effect pigments and multilayered films according to the invention is preferably 0.5 to 30 μm, particularly preferably 1 to 25 μm, very particularly preferably 4 to 18 μm.

The refractive index of the first polymer (polymer A), measured at a wavelength λ=633 nm, is preferably 1.200 to 1.700, particularly preferably 1.300 to 1.600, very particularly preferably 1.400 to 1.500. The refractive index of the second polymer (polymer B), measured at a wavelength λ=633 nm, is preferably 1.300 to 1.800, particularly preferably 1.400 to 1.700, very particularly preferably 1.550 to 1.650. The refractive index of the first polymer (polymer A) is preferably smaller than the refractive index of the second polymer (polymer B).

The refractive index difference An between the first and the second polymers at a wavelength λ=633 nm is preferably 0.001 to 0.800, in particular 0.050 to 0.300, particularly preferably 0.100 to 0.200, very particularly preferably at least 0.140.

The effect pigments and multilayered films according to the invention may also optionally be coloured or processed with biodegradable dyes, such as liquid colours (e.g. selected from the DLC series from FARRL) or precoloured master-batches (e.g. selected from the Fibaplast masterbatch series from Finke). In a particularly preferred embodiment of the invention, however, the effect pigments and multilayered films according to the invention consist exclusively of the individual layers of the first and second polymers.

The first and second polymers preferably each have a melting point in the range from 140 to 300° C. The difference between the melting points of the first and second polymers is preferably not more than 60K, particularly preferably not more than 40K.

Very particular preference is given to polymers or individual layers which have a refractive index difference Δn of ≥0.14 (at λ=633 nm), where both polymers can preferably be processed at the same temperature and have an individual layer thickness of 130 nm or less, in particular from 60 to 130 nm.

In a particularly preferred embodiment of the invention, the individual layer thicknesses for both polymers are virtually identical, i.e. the ratio of the layer volumes is approximately 50:50.

The effect pigments according to the invention preferably have a maximum diameter of 1 to 200 μm, particularly preferably 5 to 160 μm, very particularly preferably 10 to 120 μm.

The effect pigments according to the invention are preferably in flake form. The effect pigments according to the invention preferably have an aspect ratio (form factor or diameter/thickness ratio) of 1 to 200, particularly preferably 5 to 100, very particularly preferably 6 to 20.

The effect pigments according to the invention preferably have a regular n-gon shape where n=3 to 16, preferably 4 to 8. These or other preferred shapes can be produced in a manner known to the person skilled in the art through the use of tools or devices that are in each case suitable for comminuting the multilayered films, such as, for example, grinding tools.

The particle sizes are determined using commercially available instruments known to the person skilled in the art (e.g. from Malvern, Horiba) by means of laser dif-fraction on the powder or on pigment suspensions.

A further preferred embodiment of the invention relates to a mixture consisting of two or more effect pigments according to the invention having a different hue.

A further preferred embodiment of the invention relates to a mixture consisting of two or more effect pigments according to the invention having different particle sizes and/or a different hue.

The effect pigments according to the invention preferably have a colour effect with a metallic appearance, particularly preferably gold-, copper-or silver-coloured.

In a preferred embodiment of the invention, the process according to the invention for the preparation of effect pigments and multilayered films comprises the following steps:

The first and second polymers are each extruded, preferably at elevated temperature, placed one on top of the other, optionally cut, stacked and brought into a multilayered film structure through a film die, preferably at elevated temperature. The steps described above can also be repeated multiple times.

The polymer films are preferably not stretched or oriented after extrusion.

The extrusion is preferably carried out at elevated temperature, in particular at a temperature above 180° C., very particularly preferably at a temperature above 200° C.

The construction of the multilayered film through the film die is preferably carried out at elevated temperature, in particular at a temperature>160° C., very particularly preferably at a temperature>180° C.

For the preparation of the effect pigments according to the invention, the multilayered films obtained in this way are subsequently stamped, ground, cut or comminuted into particles in another manner, and the particles are optionally classified according to size.

Further suitable process conditions, assistants and devices, not described in detail here, such as extruders, film dies or grinding tools, are known to the person skilled in the art and are described in the literature.

The invention furthermore relates to the use of the effect pigments, multilayered films and formulations according to the invention as described above and below, preferably in products selected from the group consisting of cosmetic products, rinse-off products, packaging materials, decorative films, paints, printing inks and plastics.

The invention furthermore relates to formulations comprising one or more effect pigments according to the invention, in particular for use in the products and applications above and below.

The invention furthermore relates to products comprising one or more effect pigments or multilayered films according to the invention as described above and below.

The effect pigments according to the invention can be used in a variety of ways, e.g. in products selected from cosmetic products, rinse-off products, packaging materials, decorative films, inks and paints, in particular selected from cosmetic or rinse-off formulations, automotive paints, powder coatings, printing inks, security printing inks, plastics, ceramic materials, glasses, paper, paper coatings, toners for electrophotographic printing processes, seed, greenhouse films, tarpaulins, for the preparation of pigment slurries with water, organic and/or aqueous solvents, for the preparation of pigment preparations or dry preparations, for the mass colouring of foods, for the colouring of coatings of food products or pharmaceutical products and in documents of value. The production of such products is carried out in a manner as is known to the person skilled in the art.

The effect pigments according to the invention can be used in cosmetic applications, preferably, for example, in lipsticks, lip gloss, rouge, eyeliner, eye shadow, (volume) mascara, nail varnishes, day creams, night creams, body lotions, cleansing milk, body powder, sticks, hair gels, hair masks, hair dyes, hair conditioners, hair shampoos, shower gels, body washes, shower oils, bath additives, sunscreen, make-up, care creams, lotions, soaps, bath salts, toothpaste, face masks, compact powders, loose powders and gels, etc. The production of such products is carried out in a manner as is known to the person skilled in the art.

The multilayered films according to the invention are suitable, in particular, for use in cosmetic products and in and/or as packaging materials and decorative films (also referred to as effect films).

For various applications, the effect pigments according to the invention can also be used in a blend with other absorption pigments and/or effect pigments, such as pearlescent pigments, effect pigments, goniochromatic pigments, BiOCI flakes, multilayered pigments, metal pigments, organic dyes, organic coloured pigments and other pigments, such as, for example, transparent and opaque white, coloured and black pigments, and with flake-form iron oxides, holographic pigments, LCPs (liquid crystal polymers) and conventional transparent, coloured and black lustre pigments based on metal oxide-coated mica and SiO₂ flakes, etc. The effect pigments according to the invention can be mixed with commercially available (effect) pigments in any ratio.

The effect pigments and multilayered films according to the invention can also optionally be coloured using natural dyes.

Furthermore, the formulations and products according to the invention may also, besides the effect pigments according to the invention, comprise further constituents or additives, in particular selected from the group consisting of absorbents, astringents, antimicrobial substances, antioxidants, antiperspirants, antifoaming agents, antidandruff agents, antistatic agents, binders, biological additives, bleaching agents, chelating agents, deodorants, emollients, emulsifiers, emulsion stabilisers, dyes, humectants, film formers, fillers, fragrances, flavours, insect repellents, preservatives, corrosion inhibitors, cosmetic oils, solvents, oxidants, plant constituents, buffer substances, reducing agents, surfactants, propellants, opacifiers, UV filters and UV absorbers, denaturing agents, viscosity regulators, perfume and vitamins.

Even without further comments, it is assumed that a person skilled in the art will be able to use the above description to the fullest extent. The preferred embodiments and examples should therefore merely be regarded as descriptive and absolutely not as limiting disclosure in any way. All starting components are either commercially available or can be synthesised by known methods.

### Example 1

For the preparation of blue effect pigments, PLA is used as polymer A and PBAT as polymer B in a volume ratio of 50:50. PLA denotes polylactic acid, the commercial product used is Ingeo® 4043 from NatureWorks having a refractive index of n=1.454 (at 633 nm). PBAT denotes polybutylene adipate terephthalate, i.e. a random copolymer of the monomers 1,4-butanediol, adipic acid and terephthalic acid; the commercial product used is Ecoflex® F-Blend C1200 from BASF having a refractive index of n=1.598 (at 633 nm).

The two polymers A and B are extruded in a coextrusion process at 215° C., placed alternately one on top of the other, i.e. cut and stacked at 215° C., and brought into the final film form through a film die at 210° C.. This simultaneous processing at the same temperature is facilitated by the similar dynamic viscosity of the two polymers in the range 0.2-0.4 MPa*s. A multilayered film comprising a total of 64 individual layers each having an individual layer thickness of 60 nm is produced by means of five cutting/stacking operations.

The multilayered film is then cut/stamped to give particles having a size in the order of 5-200 μm, giving pigment particles which exhibit a blue hue with a metallic appearance.

### Example 2

For the preparation of greenish-metallic effect pigments, PLA is used as polymer A and PBAT as polymer B as described in Example 1.

The two polymers A and B are extruded in a coextrusion process at 215° C., placed alternately one on top of the other, i.e. cut and stacked at 215° C., and brought into the final film form through a film die at 210° C.. This simultaneous processing at the same temperature is facilitated by the similar dynamic viscosity of the two polymers in the range 0.2-0.4 MPa*s. A multilayered film comprising a total of 128 individual layers having an individual PLA layer thickness of 125 nm and an individual PBAT layer thickness of 115 nm is produced by means of six cutting/stacking operations.

The multilayered film is then cut/stamped to give particles having a size in the order of 5-200 μm, giving pigment particles which exhibit a greenish hue with a metallic appearance.

### Example 3

For the preparation of reddish-gold or copper-metallic effect pigments, PLA is used as polymer A and PBAT as polymer B as described in Example 1.

The two polymers A and B are extruded in a coextrusion process at 215° C., placed alternately one on top of the other, i.e. cut and stacked at 215° C., and brought into the final film form through a film die at 210° C.. This simultaneous processing at the same temperature is facilitated by the similar dynamic viscosity of the two polymers in the range 0.2-0.4 MPa*s. A multilayered film comprising a total of 128 individual layers having an individual PLA layer thickness of 125 nm and an individual PBAT layer thickness of 160 nm is produced in six cutting/stacking operations.

The multilayered film is then cut/stamped into particles having a size in the order of 5-200 μm, giving pigment particles which exhibit a hue with a reddish-gold or metallic copper appearance.

### Example 4

Mixing of pigment particles with a metallic green, red and blue appearance prepared in accordance with Examples 1 to 3 gives a mixture of effect pigments with a silver lustre.

The above examples confirm that effect pigments and multilayered films according to the invention can be prepared from commercially available, biodegradable polymers in a simple and inexpensive process, directly and without further additives or process steps, such as stretching, etc., and in a wide variety of colours.

By contrast, commercially available glitter pigments with a silver lustre, such as 1S Silver or 2S Bright Silver from Moplatec/RJA Plastics GmbH, do not consist, for example, of biodegradable materials, but are cut out of a polymer film built up from a PET core which is coated with aluminium on one side by vacuum vapour deposition and subsequently provided with an epoxide protective film on both sides.

1. An effect pigment, comprising two or more transparent layers of a first polymer and two or more transparent layers of a second polymer, where the two polymers have a different refractive index and the layers of the first polymer and the layers of the second polymer are arranged in an alternating sequence, and where the first polymer and the second polymer each comprise one or more biodegradable polymers.

2. The effect pigment according to claim 1, wherein each polymer layer has an average individual layer thickness 130 nm.

3. The effect pigment according to claim 1, wherein the first polymer is PLA (polylactic acid) or a PLA blend and the second polymer is PBAT (polybutylene adipate terephthalate).

4. The effect pigment according to claim 2, wherein the average individual layer thickness of each polymer layers is 40 to 130 nm.

5. The effect pigment according to claim 1, wherein the individual layers of the first and the second polymers number 7 to 2049.

6. The effect pigment according to claim 1, wherein the first polymer at a wavelength of λ=633 nm is has a refractive index of 1.200 to 1.700 and the second polymer (polymer B) at a wavelength of λ=633 nm has a refractive index of 1.300 to 1.800.

7. The effect pigment according to claim 1, wherein the first and the second polymers at a wavelength of λ=633 nm is have a refractive index difference Δn of 0.001 to 0.800.

8. The effect pigment according to claim 1, having a total thickness of all polymer layers of 0.5 to 30 μm.

9. The effect pigment according to claim 1, wherein it has a form factor (diameter/thickness ratio) of 1 to 200.

10. A process for the preparation of an effect pigment according claim 1, comprising the steps of coextruding a layer of the first and second polymers one on top of the other and stacking the layers into a multilayered film structure through a film die, wherein the coextruding and stacking steps may be repeated one or more times, and wherein the multilayered film is stamped, ground, cut or comminuted into particles in another manner.

11. A formulation comprising one or more effect pigments according to claim 1.

12. The formulation according to claim 11, comprising a cosmetic product, rinse-off product, packaging material, decorative film, paint, printing ink, or plastic.

13. A product selected from the group consisting of cosmetic products, rinse-off products, packaging materials, decorative films, paints, printing inks and plastics, comprising one or more effect pigments according to claim 1.

14. A formulation according to claim 11, comprising one or more additives selected from binders, further effect pigments, and absorption pigments.

15. A multilayered film, comprising two or more transparent layers of a first polymer and two or more transparent layers of a second polymer, where the layers of the first polymer and the layers of the second polymer are arranged in an alternating sequence, the two polymers each comprise one or more effect pigments according to claim 1, and the average individual layer thickness of all polymer layers is ≤130 nm.

16. A process for the production of a multilayered film according to claim 15 , wherein the first and second polymers are each extruded, placed one on top of the other, stacked, and brought into a multilayered film structure through a film die, wherein the preceding steps may be repeated one or more times.

17. A packaging materials or decorative films, comprising the multilayered film according to claim 15.
